(19) United States
(12) Patent Application Publication
(10) Pub. No.: US 2019/0329685 A1
(43) Pub. Date: Oct. 31, 2019

(54) A VEHICLE SEAT HAVING AN ADJUSTABLE SEATBACK AND/OR AN ADJUSTABLE CUSHION

(71) Applicants: Kurt SEIBOLD, Farmington Hills, MI (US); Adient Engineering and IP GmbH, Burscheid (DE)

(72) Inventor: Kurt SEIBOLD, Farmington Hills, MI (US)

(21) Appl. No.: 16/475,617

(22) PCT Filed: Jan. 3, 2018
(86) PCT No.: PCT/US18/12169

§ 371 Date: Jul. 2, 2019

Related U.S. Application Data
(60) Provisional application No. 62/442,689, filed on Jan. 5, 2017.

(51) Int. Cl. B60N 2/66; B60N 2/90; B60N 2/72

(52) U.S. Cl. CPC B60N 2/6673; B60N 2/72; B60N 2/99

(57) ABSTRACT

A vehicle seat including a panel and an actuating mechanism. The panel includes an elastomeric material. The actuating mechanism is connected to the panel. The actuating mechanism is configured to alter a contour of a seating surface of the panel.

### CROSS REFERENCE TO RELATED APPLICATIONS

This application claims the benefit of priority of U.S. provisional application 62/442,689 filed Jan. 5, 2017, the entire contents of which are incorporated herein by reference.

### FIELD OF THE INVENTION

The present invention relates to a vehicle seat that has an adjustable seatback and/or an adjustable cushion (user support structure).

### BACKGROUND OF THE INVENTION

Conventional seatbacks and cushions include bolsters. Conventional bolsters only provide a localized change to the contour of the seatback and cushion, which does not provide for an increased bolster contour. Conventional cushions and seatbacks do not allow for a complete contour change of the seatback and cushion by adjusting the bolsters. This provides conventional seatbacks and cushions with an interrupted seatback contour and cushion contour and localized pressure points.

### SUMMARY OF THE INVENTION

The present invention provides a seatback and a cushion that are adjustable to create uninterrupted contour changes laterally to allow for at least a highly defined bolster configuration and a flat lateral configuration. The seatback and the cushion include an elastomeric material as a supporting surface, which allows the shape of the seatback and the cushion to be reconfigured to allow for a large degree of adaptation so that the seatback and the cushion can be configured to adapt to any user's body type. The seatback and the cushion allow for adaptation of increased bolster contour.

By integrating constraint to a thermoelastic elastomer (TPE) (or other form of compliant support substrate) panel the seatback and the cushion are able to change so that any degree of lateral support may be provided to a user. The seatback and the cushion make a comfortable transition of support so that no localized pressure points are provided.

According to the present invention, a vehicle seat comprises a panel comprising an elastomeric material and an actuating mechanism that is connected to the panel. The actuating mechanism is configured to alter a contour of a seating surface of the panel.

The panel may comprise an integrated flexural rotation member that defines at least one pivot point of the panel.

The vehicle seat may further comprise a seat cushion that comprises the panel. The seating surface may be configured to engage at least a leg portion of a user.

The vehicle seat may further comprise a seatback structure that comprises the panel. The seating surface may be configured to engage at least a lumbar portion of the user.

The actuating mechanism may comprise a constraining and driving structure. The constraining and driving structure may comprise a driving member and a pivotable constraining and driving seatback structure. The driving member may be in contact with the pivotable constraining and driving seatback structure. At least a portion of the pivotable constraining and driving seatback structure may be in contact with the seatback structure.

The driving member may be actuated such that at least a portion of the constraining and driving seatback structure pivots a lateral portion of the seatback structure in an inward direction toward the user of the seatback structure and/or in an outward direction away from the user. The lateral portion may define a bolster of the seatback structure.

The seatback structure may be integrally connected to the pivotable constraining and driving seatback structure. A portion of the seatback structure may form the pivotable constraining and driving seatback structure.

The panel structure may comprise thermoplastic elastomer. The panel may be a single, integrally formed, one-piece panel.

According to the present invention, a vehicle seat comprises a panel comprising an elastomeric material and an actuating mechanism that is connected to the panel. Actuation of the actuating mechanism increases or decreases bolster support of the panel.

The actuating mechanism may comprise a constraining and driving structure.

The constraining and driving structure may comprise a pivotable constraining and driving cushion structure. The driving member may be in contact with the pivotable constraining and driving cushion structure. At least a portion of the pivotable constraining and driving cushion structure may be in contact with the cushion.

The driving member may be actuated such that at least a portion of the constraining and driving cushion structure pivots a lateral portion of the cushion in the inward direction toward the user of the seatback structure and/or in the outward direction away from the user. The lateral portion of the cushion may define a bolster of the cushion.

The cushion may be integrally connected to the pivotable constraining and driving cushion structure. A portion of the cushion may form the pivotable constraining and driving cushion structure.

According to the present invention, a vehicle seat comprises a one-piece panel comprising an elastomeric material and an actuating mechanism that is connected to the panel. Actuation of the actuating mechanism changes a contour of a seating surface of the panel such that the contour of the seating surface of the panel comprises one of increased side support of the user of the one-piece panel and decreased side support of the user of the one-piece panel.

It is apparent that the above-described features, which will also be explained below, can be used not only in the particular combination described, but also in other combinations or alone, without going beyond the scope of the present invention.

Preferred exemplary embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partial perspective view of a seat structure having a seatback structure with decreased bolster support;

FIG. 2 is a partial perspective of the seat structure of FIG. 1 the seatback structure having increased bolster support;

FIG. 3 is a front perspective view of a seatback structure;

FIG. 4 is a rear perspective view of the seatback structure of FIG. 3;

FIG. 5 is an enlarged view of an actuating mechanism associated with the seatback structure of FIG. 4;

FIG. 6 is a top sectional view of the actuating mechanism shown in FIG. 5;

FIG. 7 is a top view of the seatback of FIGS. 1 and 4 having decreased bolster support;

FIG. 8 is a top view of the seatback of FIGS. 1 and 4 having increased bolster support;

FIG. 9 is a sectional view of a seatback structure connected to the actuating mechanism of FIG. 5;

FIG. 10 is a rear perspective view of a seatback structure connected to an actuating mechanism;

FIG. 11 is a sectional view of the seatback structure connected to the actuating mechanism shown in FIG. 10;

FIG. 12 is a sectional view of a seatback structure connected to an actuating mechanism;

FIG. 13 is a sectional view of an actuating mechanism connected to a cushion of a seat structure;

FIG. 14 is another sectional view of an actuating mechanism connected to a cushion of a seat structure;

FIG. 15 is a sectional view of a seatback structure connected to an actuating mechanism;

FIG. 16 is another sectional view of the seatback structure and the actuating mechanism of FIG. 15;

FIG. 17 is a sectional view of another embodiment of an actuating mechanism and a seatback structure;

FIG. 18 is a sectional view showing the forward state and the rearward state of the seatback structure of FIG. 17;

FIG. 19 is an enlarged view of the actuating mechanism and the seatback structure of FIG. 17;

FIG. 20 is a partial perspective view of the seatback structure of FIG. 17;

FIG. 21 is a side view of the seatback structure of FIG. 17; and

FIG. 22 is a sectional view of another embodiment of an actuating mechanism and a seatback structure.

### DESCRIPTION OF THE PREFERRED EMBODIMENTS

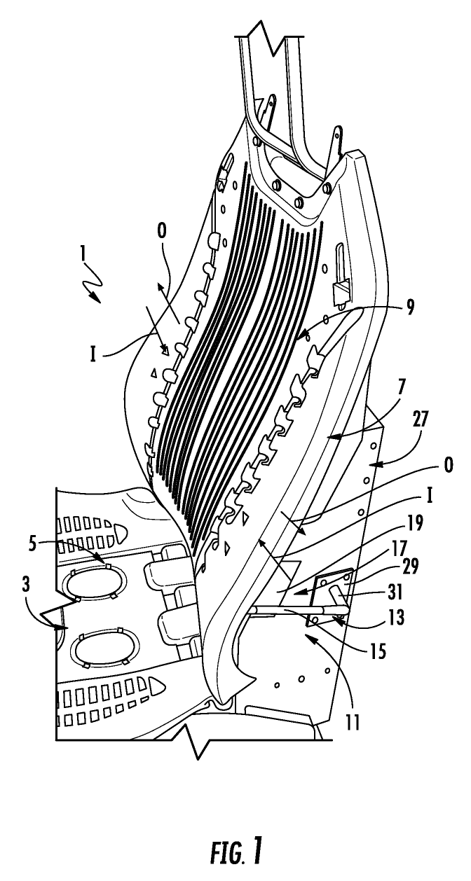

Referring to the drawings in particular, FIG. 1 is a partial perspective view of a seat structure 1. The seat structure 1 includes an user support structure (cushion) 3. The user support structure 3 has a user support structure surface 5 for engaging at least a buttock portion and a leg portion of a user. The user support structure 3 is connected to a seatback structure 7. The seatback structure 7 has a seatback structure surface 9. The seatback structure surface 9 engages at least a lumbar portion and a shoulder portion of the user. The user support structure 3 and the seatback structure 7 may be formed of any elastomeric material, but the user support structure 3 and the seatback structure 7 are preferably formed of thermoplastic elastomers (TPE). The user support structure 3 may be formed in one-piece to provide an integrally formed one-piece user support structure 3. The seatback structure 7 may be formed in one-piece to provide an integrally formed one piece seatback structure.

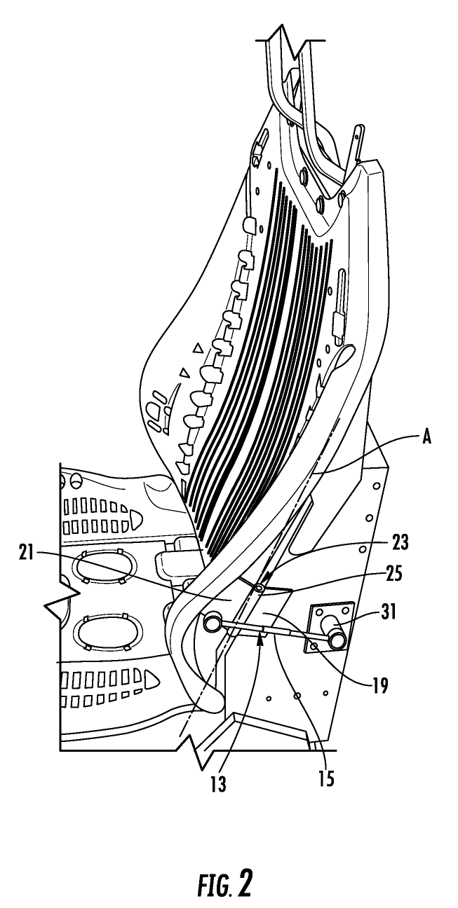

A seatback actuating mechanism 11 is connected to the seatback structure 7 on one side of the seatback structure 7 as shown in FIG. 1 and FIG. 2. Another seatback actuating mechanism (not shown in FIG. 1 and FIG. 2), which is identical to the seatback actuating mechanism 11, is provided on another side of the seatback structure 7. The two seatback actuating mechanisms may be independently controlled or the two seatback actuating mechanisms may be connected such that both seatback actuating mechanisms move simultaneously. In order to avoid repetition, only the seatback actuating mechanism 11 will be discussed as it is understood that the structure of each seatback actuating mechanism is the same in FIGS. 1 and 2. Actuation of the seatback actuating mechanism 11 changes a contour of the seatback structure surface 9 so that the seatback structure 7 has a flatter contour or a more arcuate (curved) contour.

The seatback actuating mechanism 11 includes pivotable seatback constraining/driving structure 17 that includes a driving/constraining member 13, a pivotable seatback constraining/driving first element 19 and a pivotable seatback constraining/driving second element 21. The pivotable seatback constraining/driving first element 19 and/or the pivotable seatback constraining/driving second element 21 may be integrally connected to the seatback structure 7 such that a portion of the seatback structure 7 forms the pivotable seatback constraining/driving first element 19 and/or the pivotable seatback constraining/driving second element 21. The driving/constraining member 13 may be in the form of a rod 15, but it is understood that any other structure may be provided. The rod 15 is connected to the pivotable seatback constraining/driving second element 21. The pivotable seatback constraining/driving first element 19 and the pivotable seatback constraining/driving second element 21 form a hinge, but it is understood that any other suitable structure may be used. The pivotable seatback constraining/driving first element 19 is connected to the pivotable seatback constraining/driving second element 21 via a connector element 23 such that the pivotable seatback constraining/driving second element 21 is pivotable relative to the pivotable seatback constraining/driving first element 19 about axis A. The connector element 23 is shown in a form of a pin 25 (see FIG. 2), but it is understood that any type of connector may be used to connect the pivotable seatback constraining/driving first element 19 to the pivotable seatback constraining/driving second element 21. The pivotable seatback constraining/driving first element 19 is fixed to a seat support structure 27. A motor 29 is provided in an interior of the seat support structure 27. The motor 29 is connected to a shaft 31 and the shaft 31 is connected to the driving/constraining member 13. Actuation of the motor 29 drives the shaft 31, which then drives the driving/constraining member 13 such the driving/constraining member 13 extends in a direction of the seatback structure 7. As driving/constraining member 13 extends in the direction of the seatback structure 7, the pivotable panel support structure second element 21 pivots relative to the pivotable panel support structure first element 19 in an inward direction I toward the user, which causes a side portion of the seatback structure 1 to be pressed in the inward direction I toward the user to provide the user with an increased bolster support, which changes the contour of the seatback structure surface 9. FIG. 1 shows the contour of the seatback structure surface 9 having a bolster support that is less than the bolster support shown in FIG. 2. In FIG. 1, the contour of the seatback structure surface 9 is flatter when compared with the contour of the seatback structure surface 9 shown in FIG. 2. When the pivotable seatback constraining/driving second element 21 pivots relative to the pivotable seatback constraining/driving first element 19 in the inward direction I toward the user, the contour of the seatback structure surface 9 changes to a more arcuate contour that provides the increased bolster support.

FIG. 2 is a partial perspective view of the seat structure 1 of FIG. 1. FIG. 2 shows the seatback structure 7 with the increased bolster support. Due to the increased bolster support, the contour of the seatback structure surface 9 is more arcuate than the contour of the seatback structure surface 9 shown in FIG. 1. Multiple actuating mechanisms 11 can be connected to the seatback structure 7 such that multiple segments of the seatback structure 7 can have different contours.

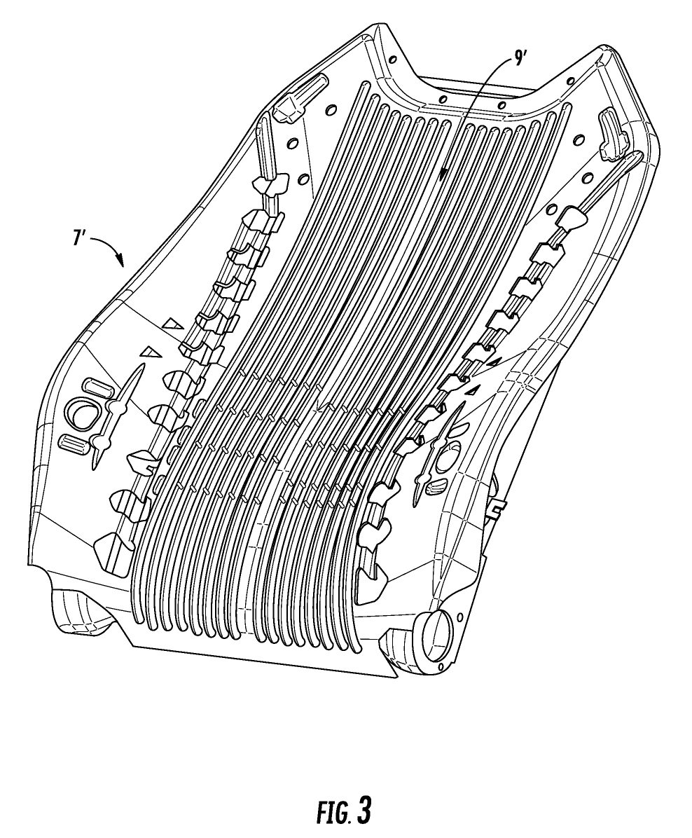

FIG. 3 is a front perspective view of a seatback structure 7′. The seatback structure 7′ is exactly the same as the seatback structure 7, except that a different actuating mechanism 11′ is used to change the contour of the seatback structure 7′.

FIG. 4 is a rear perspective view of the seatback structure 7′. A seatback connecting structure 13′ is connected to a rear surface 14′ of the seatback structure 7′. The seatback connecting structure 13′ is shown in a form of a tube 15′, however it is understood that any suitable connecting structure may be used. The actuating mechanism 11′ includes a seatback driving/constraining structure 18′. The driving/constraining structure 18′ includes an actuator structure 17′, which is shown in the form of a cable 19′. The driving/constraining structure 18′ includes another actuating structure 21′. The another actuating structure 21′ is in the form of a cable 23′. The driving/constraining structure 18′ includes an actuator 25′. The actuator 25′ includes a motor 29′ and a threaded screw shaft 27′. The threaded screw shaft 27′ has a first threaded region 39′ and a second threaded region 41′ with threads of the first threaded region being oriented in a direction opposite threads of the second threaded region 41′. The threaded screw shaft 27′ is connected to a movable cable connector 31′ and a movable cable connector 35′. The movable cable connector 31′ includes a threaded nut 33′ that has threads that engage threads of the threaded region 39′ of the threaded screw shaft 27′ and the movable cable connector includes a threaded nut 37′ that has threads that engage the threads of the threaded region 41′ of the threaded screw shaft 27′ such that the threaded nut 33′ and the threaded nut 37′ rotate when the threaded screw shaft 27′ is rotated. One end of the cable 19′ is connected to the movable cable connector 35′ and another end of the cable 19′ is connected to a driving/constraining element 43′. One end of the cable 23′ is connected to the movable cable connector 31′ and another end of the cable 23′ is connected to the driving/constraining element 43′. The driving/constraining element 43′ is pivotably mounted to a seatback structure frame 45′. When the threaded screw shaft 27′ is rotated in a first direction, the cable 19′ is pushed and the cable 23′ is pulled such that the driving/constraining element 43′ rotates in the inward direction I toward the user so that a side portion 46′ of the seatback structure 7′ is moved in the inward direction I toward the user to provide the user with increased bolster support, which changes the contour of the seatback structure surface 9′. When the threaded screw shaft 27′ is rotated in a second direction, which is opposite the first direction, the cable 17′ is pulled and the cable 23′ is pushed such that the driving/constraining element 43′ rotates in an outward direction θ away from the user so that the side portion of the seatback structure 7′ is moved in the outward direction θ away from the user to provide the user with decreased bolster support, which changes the contour of the seatback structure surface 9′ such the contour of the seatback structure 9′ is less arcuate. Another actuating mechanism, which is identical to the actuating mechanism 11′, may be provided to actuate another driving/constraining element 47′ to adjust another side portion 49′ of the seatback structure 7′. The driving/constraining element 47′ and the driving/constraining element 43′ may be moved simultaneously via actuation of the motor 25′. In another embodiment, the driving/constraining element 47′ and the driving/constraining element 43′ may be actuated independently via different motors.

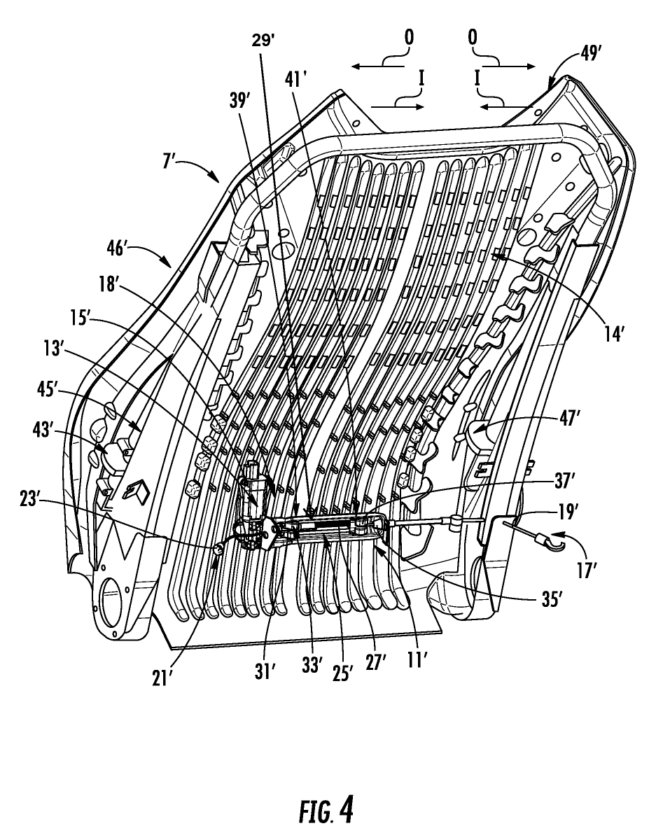

FIG. 5 is an enlarged view of the actuating mechanism 11′.

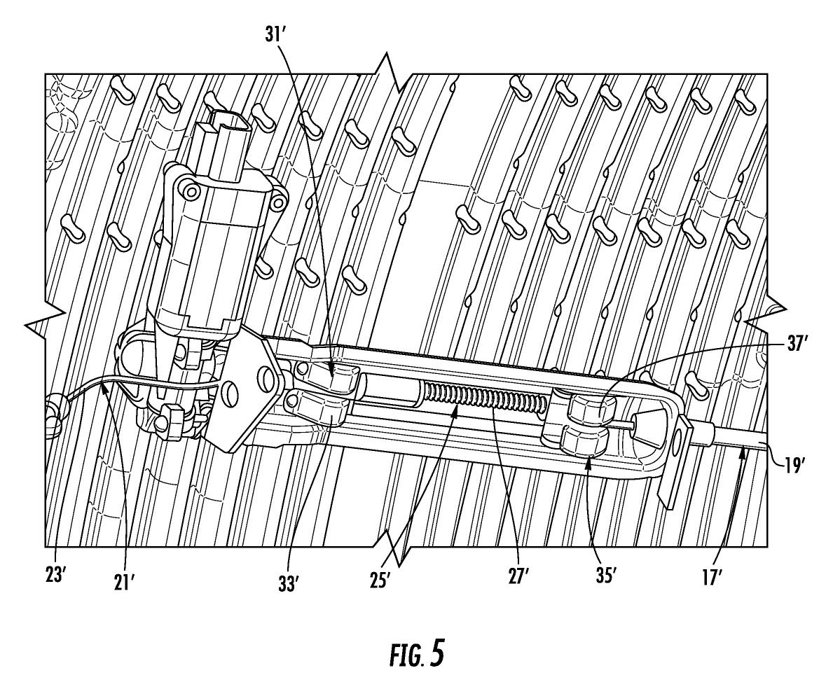

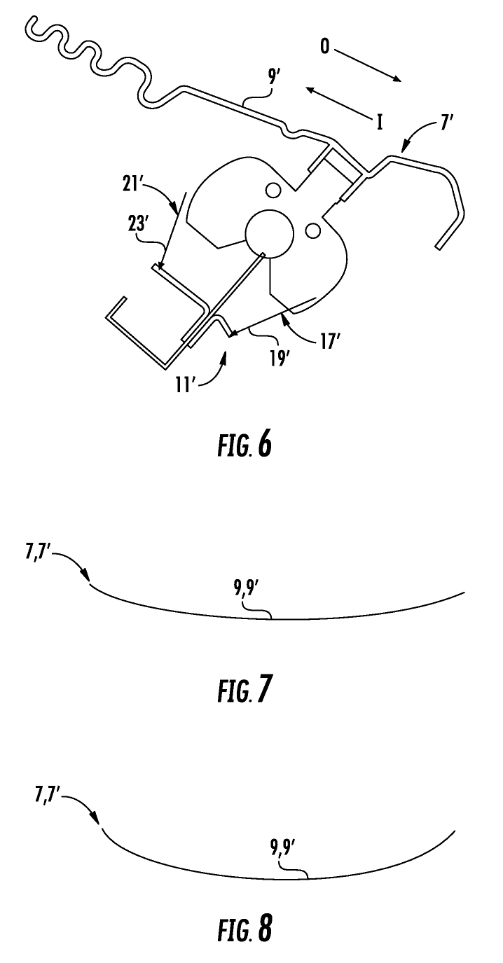

FIG. 6 is a top sectional view of the actuating mechanism 11′. When the cable 23′ is pulled, the side portion of the seatback structure 7′ is moved in the inward direction I toward the user to provide the user with increased bolster support. When the cable 19′ is pulled, the side portion of the seatback structure 7′ is moved in the outward direction θ away from the user to provide the user with less bolster support, which provides the seatback structure surface 9′ with a flatter contour when compared to the contour of the seatback structure surface 9′ when the cable 19′ is pulled. Multiple actuating mechanisms 11′ can be connected to the seatback structure 7′ such that multiple segments of the seatback structure 7′ can have different contours.

FIG. 7 and FIG. 8 are top views of the seatback structure 7, 7′. In FIG. 7, the contour of the seatback structure surface 9, 9′ has a decreased bolster support. In FIG. 8, the contour of the seatback structure 9, 9′ has an increased bolster support and a more arcuate contour when compared with the contour of the seatback structure 9, 9′ shown in FIG. 7.

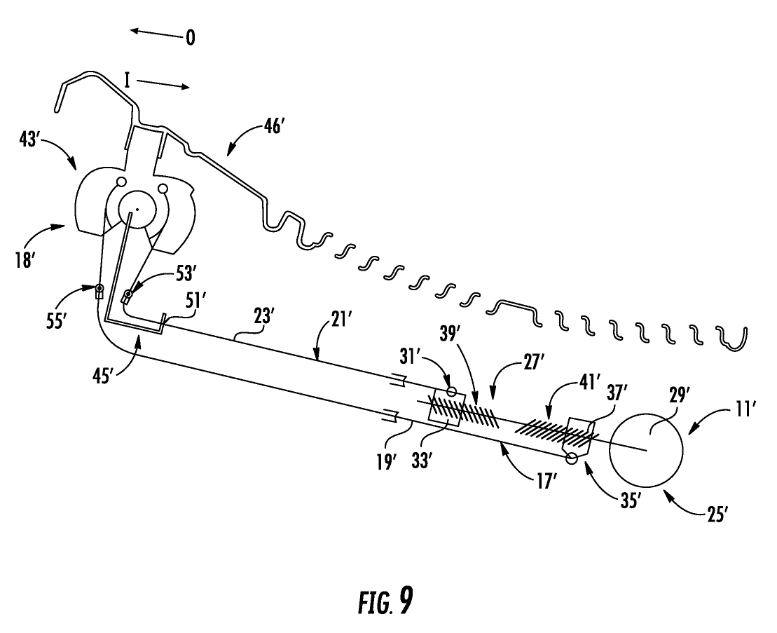

FIG. 9 is another sectional view of the actuating mechanism 11′. The cable 19′ is supported by a cable support structure 55′, which is connected to the seatback frame structure 45′. The seatback frame structure 45′ has an opening 51′. The cable 23′ extends through the opening 51′. The cable 23′ is supported by a cable support structure 53′, which is connected to the seatback frame structure 45′. The threaded region 41′ of the threaded screw shaft 27′ is shown with a right-hand thread. The threaded region 39′ is shown with a left-hand thread. When the threaded screw shaft 27′ is rotated in the first direction, the movable cable connector 35′ and the movable cable connector 31′ move toward each other so that the cable connector cable 19′ is pushed and the cable 23′ is pulled such that the driving/constraining element 43′ rotates in the inward direction I toward the user so that a side portion 46′ of the seatback structure 7′ is moved in the inward direction I toward the user to provide the user with increased bolster support. When the threaded screw shaft 27′ is rotated in the second direction, the cable connector 31′ and the cable connector 35′ move away from each other such that the cable connector 35′ pulls the cable 17′ and the cable connector pushes the cable 21′ such that the driving/constraining element 43′ rotates in the outward direction θ away from the user so that the side portion of the seatback structure 7′ is moved in the outward direction θ away from the user to provide the user with decreased bolster support. Another actuating mechanism, which is identical to the actuating mechanism 11′, may be provided to actuate another driving/constraining element to adjust another side portion of the seatback structure 7′. The two driving/constraining elements may be moved simultaneously via actuation of the actuator 25′. In another embodiment, the driving/constraining elements may be actuated independently via different actuators.

FIG. 10 is a rear perspective view of another seatback structure 7″. The seatback structure 7″ is exactly the same as the seatback structure 7 and the seatback structure 7″, except that a different actuating mechanism 11″ is used to change the contour of a seatback structure surface 9″ of the seatback structure 7″. The seatback structure 9″ engages and supports the user. The actuating mechanism 11″ may be mounted to a rear surface 14″ of the seatback structure 7″.

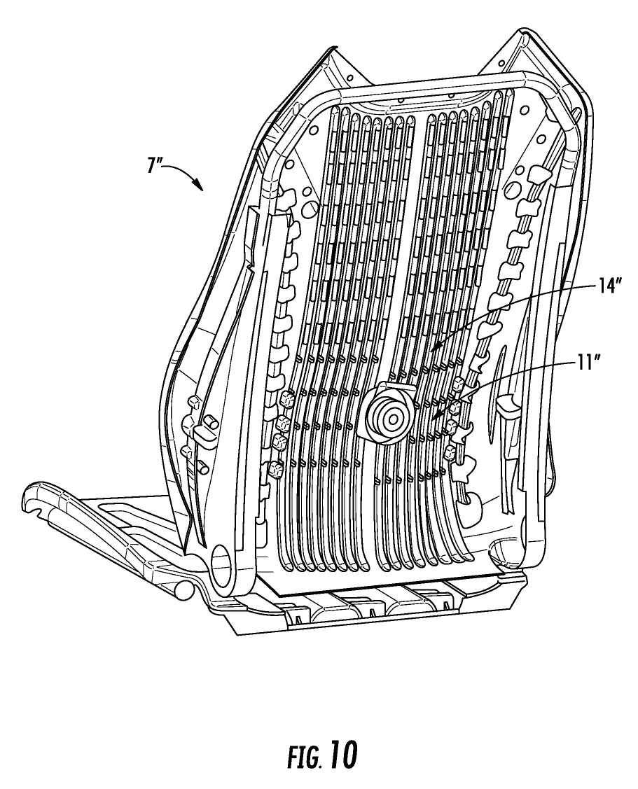

FIG. 11 is a sectional view of the actuating mechanism 11″ and the seatback structure 7″. The actuating mechanism 11″ includes a seatback driving/constraining structure 18″. The driving/constraining structure 18″ includes an actuator structure 17″, which is shown in the form of a cable 19″. The driving/constraining structure 18′ includes another actuating structure 21″. The another actuating structure 21″ is in the form of a cable 23″. The driving/constraining structure 18″ includes an actuator 25″. The actuator 25″ includes a motor 26″ and a rotatable structure 27″. The rotatable structure 27″ includes a drum 29″. One end of the cable 23″ is connected to the rotatable structure 27″ and another end of the cable 23″ is connected to a driving constraining element 43″. The driving/constraining element 43″ is connected to the seatback structure 7″. One end of the cable 19″ is connected to the rotatable structure 27″ and another end of the cable 19′ is connected to the driving/constraining element 43″. The driving/constraining element 43″ is pivotably mounted to a seatback structure frame 45″. The cable 19″ is supported by a cable support structure 55″, which is connected to the seatback frame structure 45″. The seatback frame structure 45″ has an opening 51″. The cable 23″ extends through the opening 51″. The cable 23″ is supported by a cable support structure 53″, which is connected to the seatback frame structure 45″. When the rotatable structure 27″ is rotated in a first direction B, the cable 19″ is pushed and the cable 23″ is pulled such that the driving/constraining element 43″ rotates in the inward direction I toward the user so that a side portion 46″ of the seatback structure 7′ is moved in the inward direction I toward the user to provide the user with increased bolster support, which changes the contour of the seatback structure surface 9″. When the rotatable structure 27″ is rotated in a second direction C, which is opposite the first direction, the cable 17″ is pulled and the cable 23″ is pushed such that the driving/constraining element 43″ rotates in the outward direction θ away from the user so that the side portion 46″ of the seatback structure 7″ is moved in the outward direction θ away from the user to provide the user with decreased bolster support, which changes the contour of the seatback structure surface 9″ such the contour of the seatback structure 9″ is less arcuate. Another actuating mechanism, which is identical to the actuating mechanism 11″, may be provided to actuate another driving/constraining element to adjust another side portion of the seatback structure 7″. The two driving/constraining elements may be moved simultaneously via actuation of the actuator 25″. In another embodiment, the driving/constraining elements may be actuated independently via different actuators.

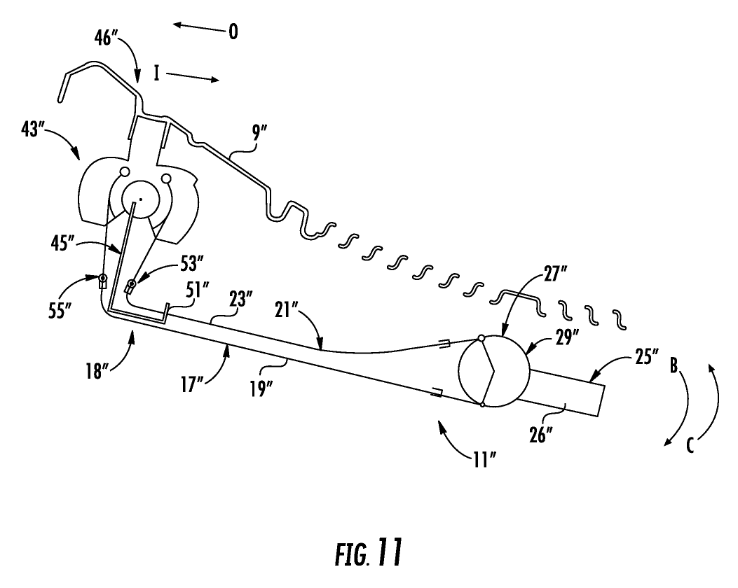

FIG. 12 is a rear perspective view of another seatback structure 7′″. The seatback structure 7′″ is exactly the same as the seatback structures previously discussed above, except that a different actuating mechanism 11′″ is used to change the contour of a seatback structure surface 9′″ of the seatback structure 7′″. The seatback structure 9′″ engages and supports the user. The actuating mechanism 11′″ includes a seatback driving/constraining structure 18′″. The driving/constraining structure 18″ includes a rotatable structure 27′″ that is connected to an actuator 25′″. The actuator 25′″ may be in the form of a motor or a manually actuated knob. The rotatable structure 27′″ includes a shaft 29′″ having a threaded region 39′″ and a threaded region 41′″. The rotatable structure 27′″ is supported by a seatback frame structure 45′″, which has a seatback structure frame portion 49′″ and a seatback structure frame portion 51′″ that is located at a spaced location from the seatback structure frame portion 49′″. Threads of the threaded region 39′″ are oriented in a direction opposite threads of the threaded region 41′″. A lateral constraint element 53′″ is connected to the seatback structure frame portion 49′″. A driving/constraining element 43′″ is pivotably connected to the seatback structure frame portion 49′″. A driving/constraining element 47′″ is pivotably connected to the seatback structure frame portion 51′″. The driving/constraining element 43′″ has threads that engage the threaded region 39′″. The driving/constraining element 47′″ has threads that engage the threaded region 41′″. When the rotatable structure rotates in a first direction B′, the driving/constraining element 43′″ and the driving/constraining element 47′″ simultaneously pivot in an inward direction I toward the user such that a side portion 46′″ of the seatback structure 7′″ and a side portion 55′″ are moved in the inward direction I toward the user to provide the user with increased bolster support, which changes the contour of the seatback structure surface 9′″. When the rotatable structure rotates in a second direction C′, which is opposite the first direction B′, the driving/constraining element 43′″ and the driving/constraining element 47′″ pivot in an outward direction O away from the user such that the side portion 46′″ of the seatback structure 7′″ and the side portion 55′″ are moved in the outward direction O away from the user to provide the user with decreased bolster support, which changes the contour of the seatback structure surface 9′″.

Although various actuating mechanisms have been described, it is understand that any suitable actuating mechanism may be used, including but not limited to a bellcrank and a direct drive.

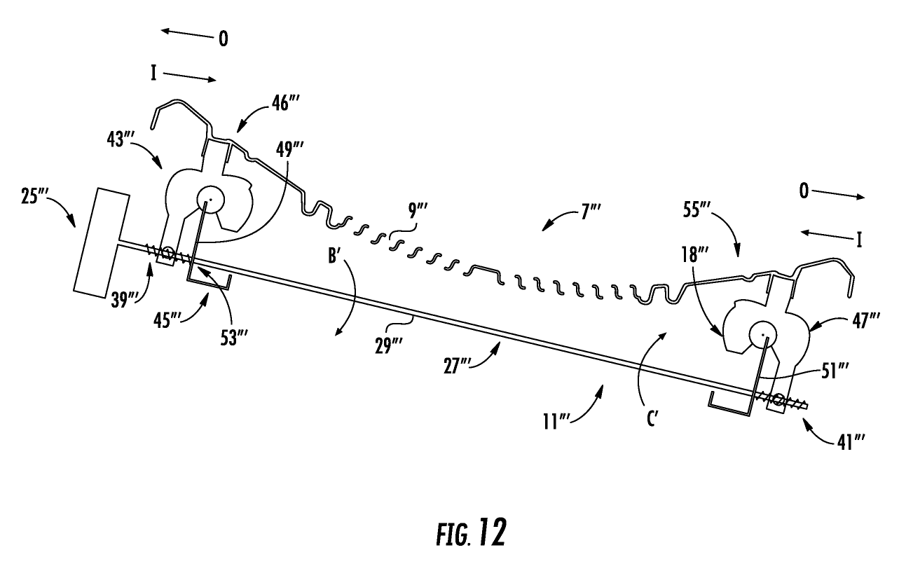

One or more of the various actuating mechanisms may be connected to the cushion 3 to move a lateral portion 4 of the cushion 3 and another lateral portion 6 of the cushion 3 to provide increased lateral (bolster) cushion support to the user. FIG. 13 is a sectional view of the actuating mechanism 11′″ connected to the cushion 3 for simultaneously moving lateral portions 4, 6 of the cushion to increase and decrease cushion bolster support for a user. The actuating mechanism 11′″ can be actuated such that the lateral portion 4 and the lateral portion 6 move in an inward direction I toward the user to provide the user with increased cushion bolster support, which changes the contour of a user engaging surface of the cushion 3, which engages and supports at least a portion of a user's legs and buttocks. The actuating mechanism 11′″ can be actuated such that the lateral portion 4 and the lateral portion 6 move in an outward direction O away from the user to provide the user with decreased cushion bolster support, which changes the contour of the cushion 3. FIG. 14 shows the actuating mechanism 11′ connected to the cushion 3 for moving lateral portions 4, 6 of the cushion 3 to increase and decrease cushion bolster support for the user. The actuating mechanism 11′ can be actuated such that the lateral portion 4 and the lateral portion 6 move in the inward direction I toward the user to provide the user with increased cushion bolster support, which changes the contour of the cushion 3. The actuating mechanism 11′ can be actuated such that the lateral portion 4 and the lateral portion 6 move in an outward direction O away from the user to provide the user with decreased cushion bolster support, which changes the contour of the cushion surface 3. Although only two examples have been shown and discussed, it is understood that any of the actuating mechanisms discussed above may be used to move the lateral portions 4, 6 of the cushion 3 to alter the contour of the user engaging surface of the cushion 3.

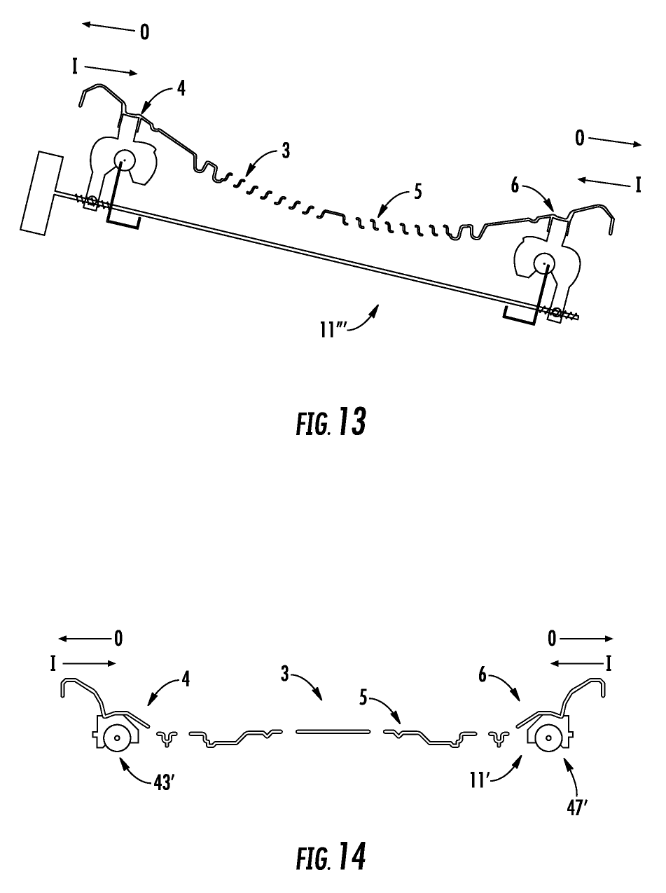

FIG. 15 is a sectional view of an actuating mechanism 11″″ and a seatback structure 7″″. The seatback structure 7″″ may be formed of any elastomeric material, but the seatback structure 7″″ is preferably formed of thermoplastic elastomers (TPE). The seatback structure 7″″ may be formed in one-piece to provide an integrally formed one piece seatback structure. The actuating mechanism 11″″ includes a seatback driving/constraining structure 18″″. The driving/constraining structure 18″″ includes an actuator structure 17″″, which is shown in the form of a cable 19″″. An actuator 25″″ is connected to the actuator structure 17″″. The actuator structure 17″″ may include a motor 26″″. One end of the actuator structure 17″″ is connected to the actuator and another end of the actuator structure 17″″ is connected to a driving/constraining element 43″″. The driving/constraining element 43″″ is formed as an integral part of the seatback structure 7″″ such that the driving/constraining element 43″″ is integrally connected to the seatback structure 7″″ and is formed in one piece with the seatback structure 7″″. The driving/constraining element 43″″ is pivotably connected to a seatback structure frame 45″″ via a seatback connecting member 48″″. In FIG. 15, the seatback connecting member 48″″ is integrally connected to the driving/constraining element 43″″ such that the seatback frame connecting member 48″″ and the driving/constraining element 43″″ are formed in one piece, however it is understood that the seatback connecting frame member 48″″ may be a separate component from the driving/constraining element 43″″. The seatback connecting frame member 48″″ engages a seatback structure frame portion 49″″ of the seatback structure frame 45″″. When the actuator is actuated 25″″, the actuator structure 17″″ is pulled such that the driving/constraining element 43″″ rotates in the outward direction θ away from the user so that a side portion 46″″ of the seatback structure 7″″ is moved in the outward direction O away from the user to provide the user with decreased bolster support, which changes the contour of a seatback structure surface 9″″ of the seatback structure 7″″ such the contour of the seatback structure 9″″ is less arcuate (flatter). FIG. 16 is a sectional view of the seatback structure 7″″ providing decreased bolster support as a result of the actuating mechanism pulling the actuating structure 17″″. When the actuator 25″″ is actuated such that tension in the actuating structure 17″″ is decreased, the driving/constraining element 43″″ rotates in the inward direction I in the direction of the user due to the elastomeric properties of the seatback structure 17″″ to provide the user with increased bolster support, which changes the contour of the seatback structure 9″″ such the contour of the seatback structure 9″″ is more arcuate (curved). The elastomeric properties of the seatback structure 9″″ allows for a hinge to be incorporated directly in the seatback structure 9″″, which simplifies construction and provides for a simpler design. Another actuating mechanism, which is identical to the actuating mechanism 11″″, may be provided to actuate another driving/constraining element, which is identical to the driving/constraining element 43″″, to adjust another side portion of the seatback structure 7″″. The two driving/constraining elements may be moved simultaneously via actuation of the actuator. In another embodiment, the driving/constraining elements may be actuated independently via different actuators.

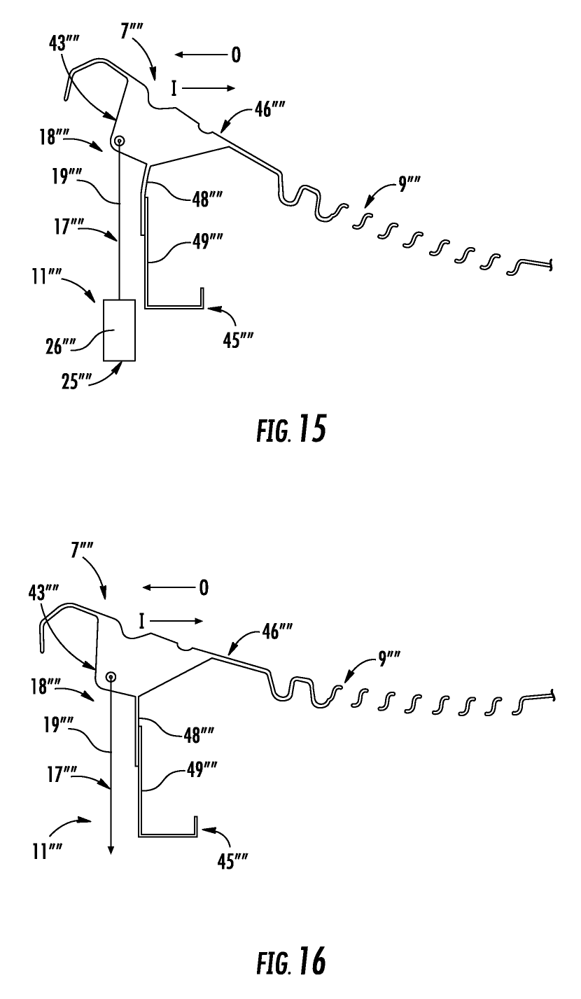

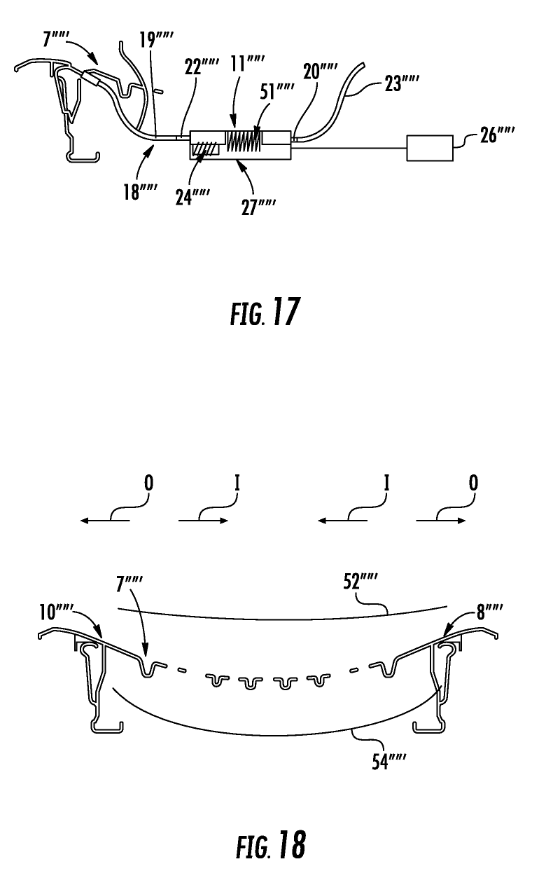

FIG. 17 is a sectional view of an actuating mechanism 11′″″ and a seatback structure 7′″″. A driving/constraining structure 18′″″ is connected to the actuating mechanism 11′″″. The actuating mechanism 11′″″ includes a rotatable threaded structure 27′″. The driving/constraining structure 18′″″ includes two cables 19′″″, 23′″″. One end of the cable 19′″″ is connected to the rotatable threaded structure 27′″″ by a cable connector 22′″. Another end of the cable 19′″″ is connected to the seatback structure 7′″. One end of the cable 23′″″ is connected to the rotatable threaded structure 27′″″ by a cable connector 20′″″. Another end of the cable 23′″″ is connected to the seatback structure 7′″″. Each of the cable connectors 20′″, 22′″″ has threads that engage threads of the rotatable threaded structure 27′″″. The rotatable threaded structure 7′″″ is connected to a motor 26′″″ that can be actuated to rotate the threaded structure 7′″″. Rotation of the rotatable threaded structure 27′″″ in a first rotational direction causes the cable connector 20′″″ and the cable connector 22′″″ to move in a direction of one another, which causes the cable 19′″″ to pull on a respective portion of the seatback structure 7′″″ and causes the cable 23′″″ to pull a respective portion of the seatback structure 7′″″ such that the seatback structure 7′″″ moves to a forward state 52′″″ and lateral side portions 8′″″, 10′″″ move in the outward direction O as shown in FIG. 18. Rotation of the rotatable threaded structure 27′″″ in a second rotational direction, which is opposite the first rotational direction, causes the cable connector 20′″″ and the cable connector 22′″″ to move in a direction away from each other, which releases the tension in the cable 19′″″ and the cable 23′″″ such that the seatback structure 7′″″ moves to a rearward state 54′″″ and lateral side portions 8′″″, 10′″″ move in the inward direction I as shown in FIG. 18. A spring 51′″″ is provided between the cable connector 20′″″ and the cable connector 22′″″ and is connected to the cable connector 20′″″ and the cable connector 23″″. The spring 51′″″ allows the seatback structure 7′″″ to go to the rearward state during a vehicular accident, which prevents whiplash to an occupant.

FIG. 18 is a sectional view showing the forward state and the rearward state of the seatback structure 7′″″.

FIG. 19 is an enlarged view showing a connection of the cable 23′″″ to the seatback structure 7″″. A cable connector structure 55′″″ is connected to a rear surface 6′″″ of the seatback structure 7′″″. The cable connector structure 55′″″ includes a rotatable connecting structure 56′″″, which is pivotably connected to connectors 58′″″, 60′″″. The connectors 58″″, 60′″″ are fixed directly to the rear surface 6′″″ of the seatback structure 7″″. When the tension is increased in the cable 23′″″ the rotatable connecting structure 56′″″ rotates relative to the connectors 58′″″, 60′″″, which causes the lateral side portion 8′″″ to pivot about an axis A′ of articulation. The connection of the cable 19′″″ to the seatback structure 7′″″ is exactly the same as shown in FIG. 19 and is not described in order to avoid repetition.

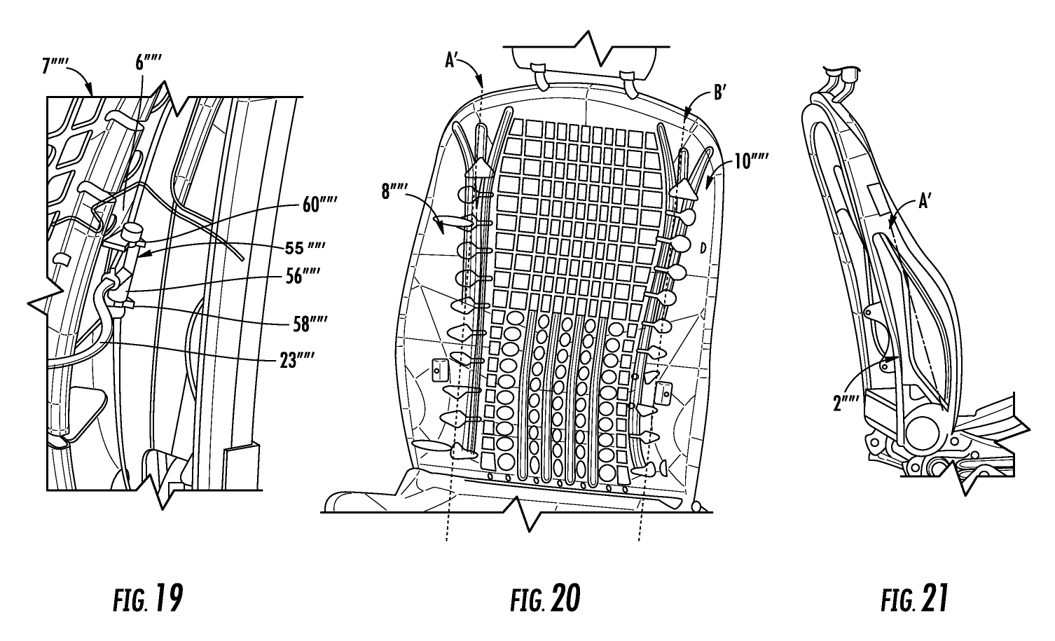

FIG. 20 is a partial perspective view of the seatback structure 7′″″. The seatback structure 7′″″ is fixed to a frame structure 2′″″, which creates the axes A′, B′ of articulation. The seatback structure 7′″″ is shown in FIG. 20 as a compliant, single, one-piece panel. The lateral side portion 10′″″ is pivotable about the axis B′ of articulation. The lateral side portion 8′″″ is pivotable about the axis A′ of articulation.

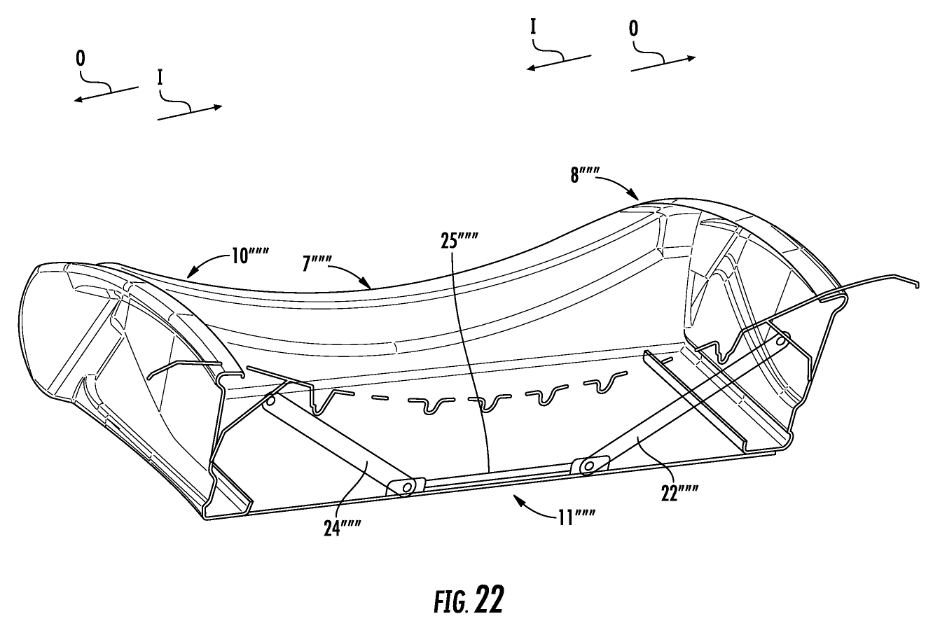

FIG. 21 is a side view of the seatback structure 7′″″ fixed to the frame structure 2′″″.

FIG. 22 is a sectional view of a seatback structure 7″″″ and an actuating mechanism 11″″″. The actuating mechanism 11″″″ is connected to a seatback driving/constraining member 22″″″ and a seatback driving/constraining member 24″″″. The driving/constraining members 22′″″, 24″″″ are connected to the seatback structure 7′″″. The actuating mechanism 11″″″ includes an actuator 25″″″ wherein actuation of the actuator 25″″″ moves the driving/constraining members 22″″″, 24″″″, which causes the contour of the seatback structure 7″″″. When the driving/constraining members 22″″″, 24″″″ move toward each other, the seatback structure moves to the forward state 52″″″ and the lateral side portions 8″″″, 10″″″ move in the outward direction O as shown in FIG. 18. When the driving/constraining members 22″″″, 24″″″ move in a direction away from each other, the seatback structure 7″″″ moves to the rearward state 54″″″ and the lateral side portions 8″″″, 10″″″ move in an inward direction I as shown in FIG. 18.

While specific embodiments of the invention have been shown and described in detail to illustrate the application of the principles of the invention, it will be understood that the invention may be embodied otherwise without departing from such principles.

While specific embodiments of the invention have been shown and described in detail to illustrate the application of the principles of the invention, it will be understood that the invention may be embodied otherwise without departing from such principles.

### LIST OF REFERENCE CHARACTERS

1 Seat structure
3 User support structure (cushion)
4 Lateral (side) portion of cushion
5 User support structure (cushion) surface
6 Lateral (side) portion of cushion
7 Seatback structure
9 Seatback structure surface
11 Seatback actuating mechanism
13 Driving/constraining member
15 Rod
17 Pivotable seatback constraining/driving structure
19 Pivotable seatback constraining/driving first element
21 Pivotable seatback constraining/driving second element
23 Connector element
25 Pin
27 Seat support structure
29 Motor
31 Shaft
7′ Seatback structure
9′ Seatback structure surface
11′ Seatback actuating mechanism
13′ Seatback connecting structure
14′ Rear surface of seatback structure
15′ Tube
17′ Actuating structure
18′ Seatback driving/constraining structure
19′ Cable
21′ Actuating structure
23′ Cable
25′ Actuator
27′ Dual direction screw
A Axis
A′ Axis
B′ Axis
29′ Motor
31′ Movable cable connector
33′ Nut
35′ Movable cable connector
37′ Nut
39′ Threaded region
41′ Threaded region
43′ Driving/constraining element
45′ Seatback structure frame
46′ Side portion of the seatback structure
47′ Driving/constraining element
49′ Side portion of the seatback structure
51′ Opening
53′ Cable support structure
55′ Cable support structure
7″ Seatback structure
9″ Seatback structure surface
11″ Actuating mechanism
14″ Rear surface of seatback structure
17″ Actuating structure
18″ Seatback driving/constraining structure
19″ Cable
21″ Actuating structure
23″ Cable
25″ Actuator
26″ Motor
27″ Rotatable member
29″ Drum
43″ Driving/constraining element
45″ Seatback structure frame
51″ Opening
53″ Cable support structure
55″ Cable support structure
7′″ Seatback structure
9′″ Seatback structure surface
11′″ Actuating mechanism
18′″ Driving/constraining structure
25′″ Actuator
27′″ Rotatable structure
29′″ Shaft
39′″ Threaded region
41′″ Threaded region
43′″ Driving/constraining element
45′″ Seatback structure frame
46′″ Lateral portion of seatback structure
47′″ Driving/constraining element
49′″ Seatback structure frame portion
51′″ Seatback structure frame portion
53′″ Lateral constraint structure
B, B′ rotational direction
C, C′ rotation direction
I inward direction
O outward direction
7″″ Seatback structure
9″″ Seatback structure surface
11″″ Actuating mechanism
17″″ Actuating structure
18″″ Driving/constraining structure
19″″ Cable
43″″ Driving/constraining element
45″″ Seatback structure frame
46″″ Lateral portion of seatback structure
48″″ Seatback frame connecting member
49″″ Seatback structure frame portion
2′″″ Frame structure
6′″″ Rear surface of seatback structure
7′″″ Seatback structure
8′″″ Lateral side portion
10′″″ Lateral side portion
18′″″ Driving/constraining structure
19′″″ Cable
20′″″ Cable connector
22′″″ Cable connector
23′″″ Cable
24′″″ Threads
11′″″ Actuating mechanism
27′″″ Rotatable threaded structure
26′″″ Motor
51′″″ Spring
52′″″ Forward state
54′″″ Rearward state
55′″″ Cable connector structure
56′″″ Rotatable connecting structure
58′″″ Connector
60′″″ Connector
7″″″ Seatback structure
8″″″ Lateral side portion
10″″″ Lateral side portion
11″″″ Actuating mechanism
22″″″ Seatback driving/constraining member
24″″″ Seatback driving/constraining member
25″″ Actuator 25″″″
52′″″ Forward state
54″″″ Rearward state

What is claimed is:

1. A vehicle seat, comprising:
a panel comprising an elastomeric material;
an actuating mechanism connected to said panel, said actuating mechanism being configured to alter a contour of a seating surface of said panel.

2. A vehicle seat in accordance with claim 1, wherein said panel comprises an integrated flexural rotation member defining at least one pivot point of said panel.

3. A vehicle seat in accordance with claim 2, further comprising:
a seat cushion comprising said panel, said seating surface being configured to engage at least a leg portion of a user.

4. A vehicle seat in accordance with claim 2, further comprising:
a seatback structure comprising said panel, said seating surface being configured to engage at least a lumbar portion of a user.

5. A vehicle seat in accordance with claim 4, wherein said actuating mechanism comprises a constraining and driving structure, said constraining and driving structure comprising a driving member and a pivotable constraining and driving seatback structure, said driving member being in contact with said pivotable constraining and driving seatback structure, at least a portion of said pivotable constraining and driving seatback structure being in contact with said seatback structure.

6. A vehicle seat in accordance with claim 5, wherein said driving member is actuated such that at least a portion of said constraining and driving seatback structure pivots a lateral portion of said seatback structure in one or more of an inward direction toward a user of the seatback structure and an outward direction away from the user of the seatback structure, said lateral portion defining a bolster of said seatback structure.

7. A vehicle seat in accordance with claim 5, wherein said seatback structure is integrally connected to said pivotable constraining and driving seatback structure, wherein a portion of said seatback structure forms said pivotable constraining and driving seatback structure.

8. A vehicle seat in accordance with claim 1, wherein said panel structure comprises thermoplastic elastomer, said panel being a single, integrally formed, one-piece panel.

9. A vehicle seat, comprising:
a panel comprising an elastomeric material;
an actuating mechanism connected to said panel, wherein actuation of said actuating mechanism one of increases and decreases bolster support of said panel.

10. A vehicle seat in accordance with claim 9, further comprising:
a seat cushion comprising said panel, said seat cushion comprising a seating surface configured to engage at least leg portion of a user.

11. A vehicle seat in accordance with claim 9, further comprising:
a seatback structure comprising said panel, said seatback structure comprising a seating surface configured to engage at least a lumbar portion of a user.

12. A vehicle seat in accordance with claim 9, wherein said actuating mechanism comprises a constraining and driving structure, said constraining and driving structure comprising a driving member and a pivotable constraining and driving seatback structure, said driving member being in contact with said pivotable constraining and driving seatback structure, at least a portion of said pivotable constraining and driving seatback structure being in contact with said seatback structure.

13. A vehicle seat in accordance with claim 12, wherein said driving member is actuated such that at least a portion of said constraining and driving seatback structure pivots a lateral portion of said seatback structure in an inward direction toward a user of the seatback structure, said lateral portion defining a bolster of said seatback structure.

14. A vehicle seat in accordance with claim 12, wherein said seatback structure is integrally connected to said pivotable constraining and driving seatback structure, wherein a portion of said seatback structure forms said pivotable constraining and driving seatback structure.

15. A vehicle seat in accordance with claim 9, wherein said panel comprises thermoplastic elastomer, said panel being a single, integrally formed, one-piece panel.

16. A vehicle seat, comprising:
a one-piece panel comprising an elastomeric material;
an actuating mechanism connected to said panel, wherein actuation of said actuating mechanism changes a contour of a seating surface of said panel such that said contour of said panel comprises one of increased side support of a user of the one-piece panel and decreased side support of the user of said one-piece panel.

17. A vehicle seat in accordance with claim 16, further comprising:
a seat cushion comprising said panel, said seating surface being configured to engage at least a leg portion of a user.

18. A vehicle seat in accordance with claim 16, further comprising:
a seatback structure comprising said panel, said seating surface being configured to engage at least a lumbar portion of a user.

19. A vehicle seat in accordance with claim 18, wherein said actuating mechanism comprises a constraining and driving structure, said constraining and driving structure comprising a driving member and a pivotable constraining and driving seatback structure, said driving member being in contact with said pivotable constraining and driving seatback structure, at least a portion of said pivotable constraining and driving seatback structure being in contact with said seatback structure.

20. A vehicle seat in accordance with claim 19, wherein said driving member is actuated such that at least a portion of said constraining and driving seatback structure pivots a lateral portion of said seatback structure in an inward direction toward a user of the seatback structure, said lateral portion defining a bolster of said seatback structure.

21. A vehicle seat in accordance with claim 20, wherein said seatback structure is integrally connected to said pivotable constraining and driving seatback structure, wherein a portion of said seatback structure forms said pivotable constraining and driving seatback structure.

22. A vehicle seat in accordance with claim 16, wherein said seatback structure comprises thermoplastic elastomer.
